(19) United States
(12) Patent Application Publication
(10) Pub. No.: US 2025/0343456 A1
(43) Pub. Date: Nov. 6, 2025

(54) ELECTRIC MACHINE COOLING

(71) Applicant: FCA US LLC, Auburn Hills, MI (US)

(72) Inventors: Karunakar Yedam, Rochester Hills, MI (US); Dhafar Al-Ani, Troy, MI (US)

(21) Appl. No.: 18/651,828

(22) Filed: May 1, 2024

(51) Int. Cl. H02K 1/32; H02K 1/20; H02K 3/24

(52) U.S. Cl. CPC H02K 1/32; H02K 1/20; H02K 3/24

(57) ABSTRACT

An electric machine includes a rotor assembly having a plurality of permanent magnets disposed within a rotor core, and a stator assembly having end windings disposed at a first end and an opposite second end of a stator core. A plurality of coolant channels extends between the stator core first and second ends and configured to receive a flow of coolant. Coolant exiting the coolant channels is directed onto the end windings for cooling thereof.

### FIELD

The present application generally relates to electric machines and, more particularly, to an electric machine thermal system for improved coolant flow.

### BACKGROUND

Electric machines, such as electric traction motors, generate heat during operation, particularly in copper conductors and permanent magnets. Exceeding the thermal limits of the electric machine components affects both electromagnetics and thermal performance, efficiency, reliability, and durability. Therefore, it is critical to provide quick and sustained cooling strategies for such components in order to meet specific technical requirements needed for all vehicle operating conditions. Conventional cooling solutions include water jackets, oil cooling, or a combination thereof. However, such solutions may be located far from the heat source and fail to cool the permanent magnets in the rotor domain and potentially cause demagnetization. Accordingly, while such systems work well for their intended purpose, there exists an opportunity for improvement in the relevant art.

### SUMMARY

According to one example aspect of the invention, an electric machine is provided. In one exemplary implementation, the electric machine includes a rotor assembly having a plurality of permanent magnets disposed within a rotor core, and a stator assembly having end windings disposed at a first end and an opposite second end of a stator core. A plurality of coolant channels extends between the stator core first and second ends and configured to receive a flow of coolant. Coolant exiting the coolant channels is directed onto the end windings for cooling thereof.

In addition to the foregoing, the described electric machine may include one or more of the following features: wherein an outlet of each coolant channel includes a nozzle configured to spray coolant onto the end windings; wherein the plurality of coolant channels includes a plurality of first coolant channels configured to flow coolant in a first direction from the stator core first end to the second end, and a plurality of second coolant channels configured to flow coolant in an opposite second direction from the stator core second end to the first end; wherein coolant exiting the first coolant channels is directed onto the end windings disposed at the stator core second end, and wherein coolant exiting the second coolant channels is directed onto the end windings disposed at the stator core first end; and wherein the stator core includes a plurality of teeth and conductive windings wound thereon, and wherein the coolant channels are disposed in close proximity to the windings to provide cooling thereto.

According to another example aspect of the invention, an electric machine is provided. In one implementation, the electric machine includes a stator assembly having a stator core and end windings, and a rotor assembly having a plurality of permanent magnets disposed within a rotor core. A plurality of coolant passages extends between opposite first and second ends of the rotor core and is configured to receive a flow of coolant. Coolant exiting the coolant passages is directed onto the end windings for cooling thereof.

In addition to the foregoing, the described electric machine may include one or more of the following features: wherein an outlet of each coolant passage includes a nozzle configured to spray coolant onto the end windings; wherein the plurality of coolant passages includes a plurality of first coolant passages configured to flow coolant in a first direction from the rotor core first end to the second end, and a plurality of second coolant passages configured to flow coolant in an opposite second direction from the rotor core second end to the first end; and wherein the stator core includes a first end and an opposite second end, wherein coolant exiting the first coolant passages is directed onto the end windings disposed at the stator core second end, and wherein coolant exiting the second coolant passages is directed onto the end windings disposed at the stator core first end.

In addition to the foregoing, the described electric machine may include one or more of the following features: wherein the coolant passages are disposed in close proximity to the permanent magnets to provide cooling thereto; wherein the coolant passages are arranged circumferentially about an outer diameter of the rotor core; and an output shaft coupled for rotation with the rotor core, wherein the output shaft includes one or more shaft coolant distribution passages fluidly coupled to the plurality of coolant passages.

According to yet another example aspect of the invention, an electric machine is provided. In one implementation, the electric machine includes a housing and a stator assembly having end windings disposed at a first end and an opposite second end of a stator core. A plurality of coolant channels extends between the stator core first and second ends and is configured to receive a flow of coolant. A rotor assembly includes a plurality of permanent magnets disposed within a rotor core, and a plurality of coolant passages extending between opposite first and second ends of the rotor core and configured to receive a flow of coolant. Coolant exiting the stator coolant channels is directed onto the end windings for cooling thereof, and coolant exiting the rotor coolant passages is directed onto the end windings for cooling thereof.

In addition to the foregoing, the described electric machine may include one or more of the following features: wherein an outlet of each stator coolant channel includes a nozzle configured to spray coolant onto the end windings, and wherein an outlet of each coolant passage includes a nozzle configured to spray coolant onto the end windings; wherein the plurality of coolant channels includes a plurality of first coolant channels configured to flow coolant in a first direction from the stator core first end to the second end, and a plurality of second coolant channels configured to flow coolant in an opposite second direction from the stator core second end to the first end.

In addition to the foregoing, the described electric machine may include one or more of the following features: wherein the plurality of coolant passages includes a plurality of first coolant passages configured to flow coolant in the first direction from the rotor core first end to the second end, and a plurality of second coolant passages configured to flow coolant in the second direction from the rotor core second end to the first end; and wherein coolant exiting the first coolant channels is directed onto the end windings disposed at the stator core second end, and wherein coolant exiting the second coolant channels is directed onto the end windings disposed at the stator core first end.

In addition to the foregoing, the described electric machine may include one or more of the following features: wherein coolant exiting the first coolant passages is directed onto the end windings disposed at the stator core second end, and wherein coolant exiting the second coolant passages is directed onto the end windings disposed at the stator core first end; and a first conduit configured to direct a flow of coolant onto the end windings disposed at the stator core first end, and a second conduit configured to direct a flow of coolant onto the end windings disposed at the stator core second end.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic view of an example electric machine and thermal system therefor, in accordance with the principles of the present application; and

FIG. 2 is a front cross-sectional view of the electric machine shown in FIG. 1, in accordance with the principles of the present application.

### DESCRIPTION

Electric machines are widely used in the automotive industry to propel vehicles with electrified powertrains, such as plug-in hybrid electric vehicles (PHEVs), fuel cell vehicles (FCVs), hydrogen with hybrid internal combustion engine (H2-ICE) vehicles, and battery electric vehicles (BEVs). As previously described, high temperatures produced during operation of the electric machines may adversely affect performance and efficiency and limit torque and power production. As such, it is desirable to quickly remove heat from the system since increased heat dissipation enables the electric machine to produce more power and torque. Accordingly, described herein are systems and methods of manufacturing electric machines, such as electric traction motors, with a thermal system to improve cooling and overall performance.

In one example, the electric machine provides efficient stator and rotor thermal management using an engineered coolant (e-fluid) or oil (e.g., automatic transmission fluid), generally referred to herein as coolant. Coolant paths or channels are formed through the stator and rotor that terminate with a spray nozzle to spray and distribute the coolant across the tightly wound end-windings. This leads to achieving an effective heat balance (less losses) at peak/continuous operating conditions along with an increased speed range (zero to max) of the electric machine.

In this way, expensive components, such as permanent magnets and copper, can be replaced with more cost-effective materials while avoiding critical demagnetization and short circuit risks, and increasing power and torque performance. Advantages of the described system include (i) the ability to handle any type of cross-section for coolant flow with less restriction, (ii) quickly reaching hot spots to dissipate heat efficiently, (iii) enabling high continuous performance (e.g., >75% of peak torque and power), (iv) oil/e-fluid appears like water and behaves like oil, reducing entrapment between stator and rotor domains, (v) reduced weight and required pumping power, (vi) a single cooling circuit for the entire electric drive system using the same coolant for electric machines, power inverters, driveline gears, batteries, and hybrid engines, and (vii) nozzles placed around copper conductors and configured to provide coolant to all four sides of the end-windings.

The described system provides rapid cooling to mitigate hot spots in stator and rotor domains with unique coolant routings designed close to the heat sources. Various cross-sectional shapes may be utilized for the coolant channels (e.g., oval, circular) and channel routing is easily designed upfront and easy to manufacture. Advantageously, the system improves overall efficiency of the electric machines by reducing the losses generated from electromagnetic interactions with thermal designs. Further, in some examples, the system provides significant improvement of continuous performance by achieving >75% of peak performance while running in both motoring/generating modes.

Additionally, the system supports structural rigidity and minimizes stresses in electric steel laminations (stator and rotor) with effective e-fluid/oil circulation. Furthermore, the coolant may be heated quickly during freezing weather conditions and circulated with less restriction versus oil due to its density difference. This will also reduce the power consumption by the oil pump due to quick heating of the coolant.

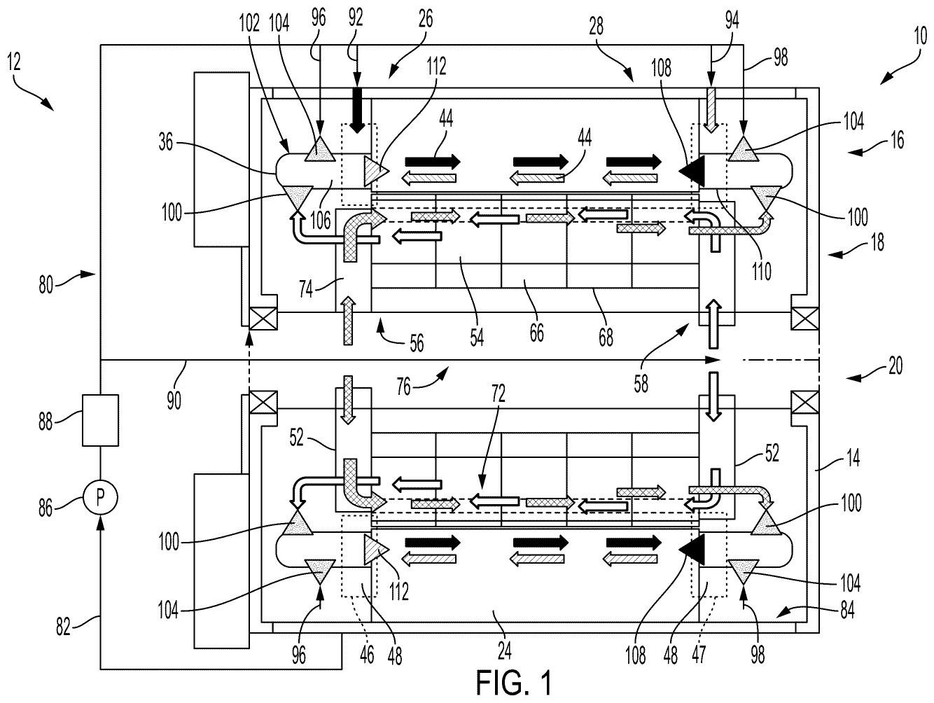

Referring now to FIG. 1, a schematic cross-section of an example electric machine is illustrated and generally identified at reference numeral 10. In the example embodiments, the electric machine 10 is described as an electric traction motor for an electric vehicle, but it will be appreciated that the features described herein may be applied to various electric machines. In general, the electric machine 10 includes a thermal system 12 configured to provide increased heat transfer and thereby rapidly cool the electric machine 10 to improve torque, power, and efficiency. However, it will be appreciated that due to the increased heat transfer capability, the thermal system 12 may also rapidly heat the electric machine 10 to improve performance in low temperature conditions (e.g., below 0° C.).

In the illustrated example, the electric machine 10 generally includes a housing 14 containing a stator assembly 16 operably associated with a rotor assembly 18 and an output shaft 20. In general, the stator assembly 16 receives electrical power to produce a magnetic field, which interacts with a magnetic field of the rotor assembly 18 to produce mechanical power to the shaft 20.

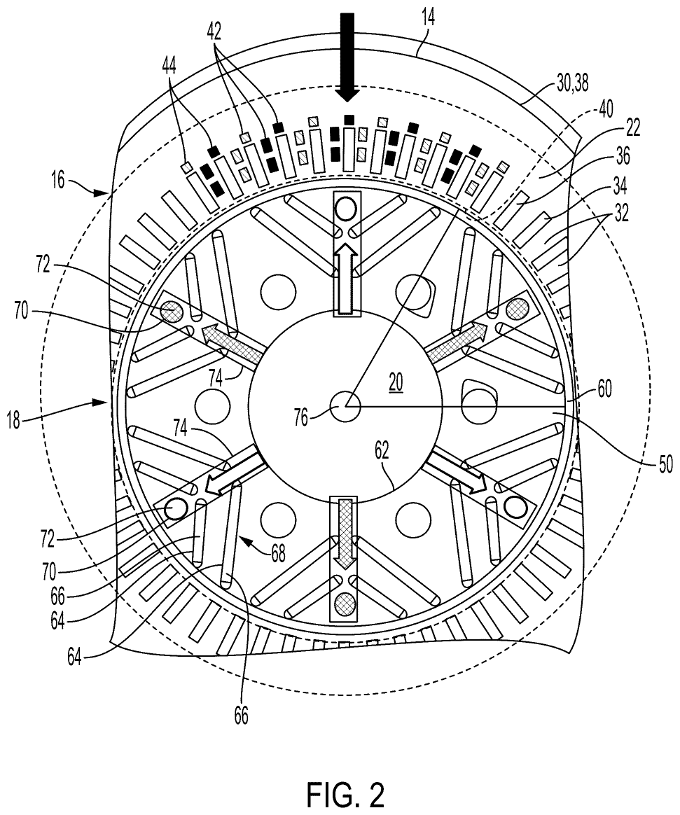

With additional reference to FIG. 2, in the example embodiment, the stator assembly 16 is formed from a plurality of individual annular stator laminations 22 (only one shown). The stator laminations 22 are stacked one on top of the other to a length known as the stack length, which determines the torque and power output of the electric machine 10. The stator laminations 22 are coupled together, for example, by gluing, interlocking, welding, or other suitable joining technique to form a stator core or stack 24 having a first end 26 and an opposite second end 28 (FIG. 1). The number of stator laminations 22 of the stack 24 can be based on design considerations and, as such, stator assembly 16 may have any suitable number of stator laminations 22. Alternatively, the stator core may be a solid structure rather than formed from laminations.

In the illustrated example, each stator lamination 22 is fabricated from a magnetic steel in a punching die, laser cut, 3D printing, etc. (not shown) to produce a generally annular component (partially shown) having a back iron 30 with a plurality radially aligned teeth 32 extending radially inward from the back iron 30. The stator teeth 32 define slots 34 therebetween through which coil windings 36 are wound. The back iron 30 defines an outer diameter 38, and the distal end of each stator tooth 32 defines an inner diameter edge 40.

As shown in FIG. 2, each stator lamination 22 is formed with a plurality of apertures 42. During assembly, the stator laminations 22 are stacked such that the apertures 42 are aligned to define a channel 44 through the stacked configuration. As will be described in more detail, each channel 44 is configured to receive a flow of coolant in a first direction from the stator first end 26 to the second end 28, or in an opposite second direction from the stator second end 28 to the first end 26. In the illustrated example, channels 44 are arranged proximate to slots 34 to be in close proximity to the heat generating windings 36 and provide improved cooling thereto. However, it will be appreciated that channels 44 may be located in various other locations in the stator lamination 22 and have any desired number of channels 44.

With continued reference to FIG. 1, the stack of stator laminations 22 are disposed between a pair of manifolds or inlets 46, 47. Each inlet 46, 47 defines a coolant channel 48, which is fluidly connected to an inlet of the individual stator coolant channels 44 for circulating the coolant therethrough. As such, the inlet coolant channels 48 receive a supply of coolant, which is subsequently supplied to the stator coolant channels 44. The front inlet 46 is disposed at the stator first end 26 and is fluidly coupled to a first portion of the channels 44 to supply coolant in the first direction from the first end 26 to the second end 28. The rear inlet 47 is disposed at the second end 28 and is fluidly coupled to a second portion of the channels 44 to supply coolant in the second direction from the second end 28 to the first end 26. In this way, a flow of colder coolant is supplied at each end 26, 28 to evenly distribute cooling across the stator assembly 16.

With continued reference to FIG. 2, in the example embodiment, the rotor assembly 18 is formed from a plurality of individual annular rotor laminations 50 (only one shown) with a pair of opposed short-circuit rings or end caps 52 (FIG. 1). The rotor laminations 50 are stacked one on top of the other to a stack length, which further determines the torque and power output of the electric machine 10. The rotor laminations 50 are coupled together, for example, by gluing, interlocking, welding, or other suitable joining technique to form a rotor core or stack 54 having a first end 56 and an opposite second end 58. The number of rotor laminations 50 of the stack 54 can be based on design considerations and, as such, rotor assembly 18 may have any suitable number of rotor laminations 50. Alternatively, the rotor core may be a solid structure rather than formed from laminations.

In the illustrated example, each rotor lamination 50 is fabricated from a magnetic steel in a punching die, laser cut, 3D printing, etc. (not shown) to produce a generally circular or annular component having an outer diameter 60, an inner diameter 62, and a plurality of slots or apertures 64 for receiving one or more permanent magnets 66. The outer diameter 60 faces the stator inner diameter edge 40, and the inner diameter 62 receives and is mechanically coupled (e.g., splined) to the shaft 20. During assembly, the rotor laminations 50 are stacked such that the apertures 64 are aligned to define passages 68 for the permanent magnets 66.

Additionally, as shown in FIG. 2, each stator lamination is formed with a plurality of second apertures 70. During assembly, the rotor laminations 50 are stacked such that the second apertures 70 are aligned to define coolant channels or passages 72 through the stacked configuration. As will be described in more detail, each coolant passage 72 is configured to receive a flow of coolant in the first direction from the rotor first end 56 to the second end 58, or in the opposite second direction from the rotor second end 58 to the first end 56. In the illustrated example, coolant passages 72 are arranged generally circumferentially about the rotor outer diameter 60 and in close proximity to the heat generating permanent magnets 66 to provide improved cooling thereto. However, it will be appreciated that passages 72 may be located in various other locations in the rotor lamination 50 and have any desired number of passages 72.

With continued reference to FIG. 1, the stack of stator laminations 50 is disposed between the opposed end caps 52. Each end cap 52 is also formed with one or more radially extending coolant channels 74 (see also FIG. 2), which are fluidly connected to the coolant passages 72 for circulating the coolant therethrough. The end ring coolant channels 74 are fluidly coupled to the output shaft 20 to receive a flow of coolant therefrom. As shown in FIGS. 1 and 2, the shaft 20 includes one or more coolant distribution passages 76 configured to receive a flow of coolant. As such, the shaft coolant distribution passages 76 supply coolant to the end ring coolant channels 74, which subsequently supply the coolant to the individual coolant passages 72.

With continued reference to FIG. 2, the thermal system 12 will be described in more detail. In the example embodiment, the thermal system 12 generally includes a coolant loop or circuit 80 that includes a main conduit 82 configured to receive heated coolant from the electric machine 10, for example, via a sump 84 of the housing 14. A pump 86 circulates the coolant through coolant circuit 80 such that heated coolant from sump 84 is directed to a heat exchanger 88 for cooling of the heated coolant.

A first portion of the cooled coolant is then directed through a first conduit 90 fluidly coupled to the shaft coolant distribution passages 76. A second portion of the cooled coolant is directed through a second conduit 92 to provide coolant to the stator front inlet 46, and a third portion of the cooled coolant is directed through a third conduit 94 to provide coolant to the stator rear inlet 47. In the example embodiment, equal or substantially equal flows are provided to the stator inlets 46, 47 for even cooling, but flows may be adjusted based on heating/cooling requirements. In some embodiments, a fourth portion of the cooled coolant is directed through a fourth conduit 96, and a fifth portion of the cooled coolant is directed through a fifth conduit 98, as described herein in more detail.

The first portion of coolant in first conduit 90 is directed to the shaft coolant distribution passage(s) 76, which are formed in the output shaft 20. The first portion of coolant then flows to the end ring coolant channels 74, and subsequently into the rotor coolant passages 72. The first portion of coolant flows from one end cap 52 toward the opposite end cap 52 while absorbing heat from the rotor assembly 18 and permanent magnets 66. Upon reaching the opposite side of the rotor assembly 18, the first portion of coolant is directed through one or more nozzles 100, which are configured to spray the coolant onto a distal end 102 of the windings 36 for cooling thereof, as shown in FIG. 1. The first portion of coolant then drains to the sump 84 and is returned to pump 86 to repeat the cycle.

The remaining coolant from heat exchanger 88 is circulated through coolant circuit 80 to conduits 92-98. The fourth and fifth conduits 96, 98 are each fluidly coupled to one or more nozzles 104 configured to spray the coolant onto an intermediate portion 106 of the windings 36 for cooling thereof, as shown in FIG. 1. The fourth and fifth portions of coolant then drain to the sump 84 and are returned to pump 86 to repeat the cycle.

The second portion of coolant in second conduit 92 is directed to the stator front inlet 46. Coolant is then directed through inlet coolant channels 48 to the stator coolant channels 44 fluidly coupled thereto. The coolant flows in stator coolant channels 44 from front inlet 46 toward the opposite rear inlet 47 (as shown by arrows) while absorbing heat from the stator assembly 16 and windings 36 for cooling thereof, as shown in FIG. 1. Upon reaching the opposite side of the stator assembly 16, the second portion of coolant is directed through one or more nozzles 108, which are configured to spray the coolant onto a proximal end 110 of the windings 36 for cooling thereof. The second portion of coolant then drains to the sump 84 and is returned to pump 86 to repeat the cycle.

In a similar, but opposite direction, the third portion of coolant in third conduit 94 is directed to the stator rear inlet 47. Coolant is then directed through inlet coolant channels 48 to the stator coolant channels 44 fluidly coupled thereto. The coolant flows in stator coolant channels 44 from rear inlet 47 toward the opposite front inlet 46 (as shown by arrows) while absorbing heat from the stator assembly 16 and windings 36 for cooling thereof, as shown in FIG. 1. Upon reaching the opposite side of the stator assembly 16, the third portion of coolant is directed through one or more nozzles 112, which are configured to spray the coolant onto the proximal end 110 of the windings 36 for cooling thereof. The third portion of coolant then drains to the sump 84 and is returned to pump 86 to repeat the cycle.

Described herein are systems and methods for manufacturing electric machines, such as electric traction motors, with improved cooling. A thermal system is fluidly coupled to the electric machine and configured to provide a flow of coolant in multiple locations to cool the electric machine. One flow of coolant is provided through the rotor shaft to opposite sides of the rotor, and then through channels in the rotor to the opposite side of rotor where it is sprayed via a nozzle onto stator end windings. Another flow of coolant is provided to opposite sides of the stator, and then through channels in the stator to the opposite side of the stator, where it is subsequently sprayed via nozzles onto the stator windings. Additional flow is provided directly to nozzles and further onto the stator windings. Accordingly, coolant flow is provided to multiple regions of the electric machine for distributed cooling to quickly and efficiently dissipate heat produced by the electric machine.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electric machine, comprising:
a rotor assembly having a plurality of permanent magnets disposed within a rotor core; and
a stator assembly having end windings disposed at a first end and an opposite second end of a stator core, and a plurality of coolant channels extending between the stator core first and second ends and configured to receive a flow of coolant,
wherein coolant exiting the coolant channels is directed onto the end windings for cooling thereof.

2. The electric machine of claim 1, wherein an outlet of each coolant channel includes a nozzle configured to spray coolant onto the end windings.

3. The electric machine of claim 1, wherein the plurality of coolant channels comprises:
a plurality of first coolant channels configured to flow coolant in a first direction from the stator core first end to the second end; and
a plurality of second coolant channels configured to flow coolant in an opposite second direction from the stator core second end to the first end.

4. The electric machine of claim 3, wherein coolant exiting the first coolant channels is directed onto the end windings disposed at the stator core second end, and
wherein coolant exiting the second coolant channels is directed onto the end windings disposed at the stator core first end.

5. The electric machine of claim 1, wherein the stator core includes a plurality of teeth and conductive windings wound thereon, and
wherein the coolant channels are disposed in close proximity to the windings to provide cooling thereto.

6. An electric machine, comprising:
a stator assembly having a stator core and end windings; and
a rotor assembly having a plurality of permanent magnets disposed within a rotor core, and a plurality of coolant passages extending between opposite first and second ends of the rotor core and configured to receive a flow of coolant,
wherein coolant exiting the coolant passages is directed onto the end windings for cooling thereof.

7. The electric machine of claim 6, wherein an outlet of each coolant passage includes a nozzle configured to spray coolant onto the end windings.

8. The electric machine of claim 6, wherein the plurality of coolant passages comprises:
a plurality of first coolant passages configured to flow coolant in a first direction from the rotor core first end to the second end; and
a plurality of second coolant passages configured to flow coolant in an opposite second direction from the rotor core second end to the first end.

9. The electric machine of claim 8, wherein the stator core includes a first end and an opposite second end,
wherein coolant exiting the first coolant passages is directed onto the end windings disposed at the stator core second end, and
wherein coolant exiting the second coolant passages is directed onto the end windings disposed at the stator core first end.

10. The electric machine of claim 6, wherein the coolant passages are disposed in close proximity to the permanent magnets to provide cooling thereto.

11. The electric machine of claim 6, wherein the coolant passages are arranged circumferentially about an outer diameter of the rotor core.

12. The electric machine of claim 6, further comprising an output shaft coupled for rotation with the rotor core,
wherein the output shaft includes one or more shaft coolant distribution passages fluidly coupled to the plurality of coolant passages.

13. An electric machine, comprising:
a housing;
a stator assembly having end windings disposed at a first end and an opposite second end of a stator core, and a plurality of coolant channels extending between the stator core first and second ends and configured to receive a flow of coolant; and
a rotor assembly having a plurality of permanent magnets disposed within a rotor core, and a plurality of coolant passages extending between opposite first and second ends of the rotor core and configured to receive a flow of coolant, wherein coolant exiting the stator coolant channels is directed onto the end windings for cooling thereof, and
wherein coolant exiting the rotor coolant passages is directed onto the end windings for cooling thereof.

14. The electric machine of claim 13, wherein an outlet of each stator coolant channel includes a nozzle configured to spray coolant onto the end windings, and
wherein an outlet of each coolant passage includes a nozzle configured to spray coolant onto the end windings.

15. The electric machine of claim 13, wherein the plurality of coolant channels comprises:
a plurality of first coolant channels configured to flow coolant in a first direction from the stator core first end to the second end; and
a plurality of second coolant channels configured to flow coolant in an opposite second direction from the stator core second end to the first end.

16. The electric machine of claim 15, wherein the plurality of coolant passages comprises:
a plurality of first coolant passages configured to flow coolant in the first direction from the rotor core first end to the second end; and
a plurality of second coolant passages configured to flow coolant in the second direction from the rotor core second end to the first end.

17. The electric machine of claim 16, wherein coolant exiting the first coolant channels is directed onto the end windings disposed at the stator core second end, and
wherein coolant exiting the second coolant channels is directed onto the end windings disposed at the stator core first end.

18. The electric machine of claim 17, wherein coolant exiting the first coolant passages is directed onto the end windings disposed at the stator core second end, and
wherein coolant exiting the second coolant passages is directed onto the end windings disposed at the stator core first end.

19. The electric machine of claim 13, further comprising:
a first conduit configured to direct a flow of coolant onto the end windings disposed at the stator core first end, and
a second conduit configured to direct a flow of coolant onto the end windings disposed at the stator core second end.
